(19) United States
(12) Patent Application Publication
(10) Pub. No.: US 2009/0327546 A1
(43) Pub. Date: Dec. 31, 2009

(54) System for and method of hand-off between different communication standards

(76) Inventors: Gaby Guri, Oranit (IL); Doron Solomon, Holon (IL)

Correspondence Address: MCDERMOTT WILL & EMERY LLP, 28 STATE STREET, BOSTON, MA, 02109-1775, US

(21) Appl. No.: 11/649,146

(22) Filed: Jan. 2, 2007

Related U.S. Application Data
(63) Continuation-in-part of application No. 11/071,340, filed on Mar. 3, 2005, now Pat. No. 7,568,059.

(51) Int. Cl. G06F 13/42

(52) U.S. Cl. 710/106; 710/105

(57) ABSTRACT

An integrated chip for use in processing signals encoded in accordance with either one of at least two communication protocols comprises: reconfigurable architecture capable of being selectively arranged into different configurations, at least one configuration corresponding to each respective protocol so as to implement the functionality of the respective protocol with a predetermined complexity, and an intermediate configuration for implementing the hand-off between a first protocol and a second protocol. The intermediate configuration is arranged so as to simultaneously implement the basic functionality of both the first and second protocols during hand-off, and implementation of at least one of the protocols is of lesser complexity than of the corresponding predetermined complexity associated with separately implementing the other of the protocols. A wireless communication device which utilize the chip in the form of configware, can also include an antenna for receiving or transmitting a signal encoded in accordance with anyone of a plurality of communication protocols; and a baseband processor for processing the signals received or transmitted by the antenna. Finally, a method is described.

### RELATED APPLICATIONS

The present application is a continuation in part of U.S. Ser. No. 11/071,340 filed Mar. 3, 2005 in the name of Doron Solomon and Gilad Garon, assigned to the present assignee, and published as United States Patent Published Application No. 2006/0010272 (Jan. 12, 2006) directed to a Low-Power Reconfigurable Architecture For Simultaneous Implementation Of Distinct Communication Standards.

### FIELD

The present disclosure relates to wireless communications, and more particularly to a system for and method of hand-off when processed signals are changed from one communication standard to another.

### BACKGROUND

The advent of the availability of a diverse set of heterogeneous wireless networks employing different communication protocols or standards poses a problem of universal seamless access. One of the main challenges for seamless mobility is the availability of reliable vertical (intersystem) handoff schemes. Efficient handoff schemes enhance quality of service and provide flawless mobility.

This problem becomes especially acute with the introduction of the fourth generation (4G) of wireless communications, which are capable of integrating a large number of different wireless technologies. Q. Zhang et al. “Efficient mobility management for vertical handoff between WWAN and WLAN,” IEEE Communication Magazine, vol. 41, no. 11, 2003, pp. 102-108. The system requirements in 4G assume smooth and quick seamless handoff.

Where heterogeneous networks are present, each mobile terminal is within range (within a cell) of at least one network access point. The cells in general are overlaid within each other, and it is the key issue for a mobile host to decide which base station of which network should be accessed. This disclosure considers only vertical handoffs, e.g. the changeover of signal transmission from a Wi-Fi (IEEE 802.11) base station to an overlaid cellular network.

In cellular telecommunications, the term “handoff” refers to the process of transferring an ongoing call or data session from one channel connected to the core network to another. The main requirement is that it should not lead to an interruption of service. There are two types of hand-offs: horizontal and vertical. In the horizontal handoff the service is transferred between two base stations employing the same protocol. In this case there is no need for changing the structure and parameters of the modem that is used. In the vertical handoff, however, there is a transfer between distinct networks employing different communication standards, e.g., between GSM and WLAN. In this latter case, upon accomplishment of the transfer a completely different protocol and modem should be activated.

Handoffs can be hard or soft. With a hard handoff, a mobile terminal is allowed to maintain connection with only one base station at a given time. Contrary to hard handoffs, with a soft handoff, a mobile terminal maintains a radio connection with at least two base stations simultaneously. Though a soft handoff provides a smoother regime for the transfer of a transmission from one base station to another, the hard handoff is more common in vertical handoffs.

There are two types of vertical handoffs: upward and downward. An upward vertical handoff is roaming to an overlay with lower bandwidth, and a downward vertical handoff is roaming to an overlay with a larger bandwidth. See, for example, N. Nasser, A. Hasswa, H. Hassanein, “Handoffs in fourth generation heterogeneous networks,” IEEE Communications Magazine, October 2006, pp. 96-134. Downward vertical handoffs are less time critical, since a mobile device can remain connected to the upper overlay.

For seamless vertical handoffs, low delay and minimal packet loss are critical. J. McNair and F. Zhu, “Vertical handoffs in fourth-generation multi-network environments,” IEEE Wireless Communications, vol. 11, no. 3, 2004, pp. 8-15. This can be achieved by taking into consideration network conditions for vertical handoff and connection maintenance. C. Guo et al., “A seamless and proactive end-to-end mobility solution for roaming across heterogeneous wireless networks,” IEEE JSAC, vol. 22, no. 5, 2004, pp. 834-848.

The requirements of reliability of a handoff procedure and minimization of the number of handoff attempts (power saving) lead to its implementation only under conditions when the goal network exhibits unquestionably good receipt-transmit conditions. N. Nasser and H. Hassanein, “Radio resource management algorithms in wireless cellular networks,” Handbook of Algorithms for Wireless Networking and Mobile Computing, A. Boukerch, Ed., Ch. 18, Chapmann Hall, CRC Press, pp. 415-447. When the right conditions exist, the handoff process, usually comprising the steps of handoff decision, radio link transfer and channel assignment, will occur. I. F. Akyildiz et al., “Mobility management in next-generation wireless systems,” Proc. IEEE, vol. 87, no. 8, 1999, pp. 1347-1384. Moreover, signal strength and channel availability are not the only factors that have an effect on whether a handoff should take place. Other characteristics are quality of service, cost of service, security, power requirements, etc. F. Zhu and J. McNair, “Optimizations for vertical handoff decision algorithms,” Proc. IEEE WCNC, 2004, pp. 867-872. A mathematical framework for analysis of vertical handoffs has been presented in A. Hatami et al., “Analytical framework for handoff in non-homogeneous mobile data networks,” Proc. PIMRC'99, Osaka, Japan, 1999, pp. 760-764.

The standard way of implementing a vertical hand-off is by using a system containing two (or more) independent modems, one for each standard to be addressed, and a block configured to make a decision about the hand-off which implements the switch between the modems when necessary. During the hand-off there is usually a time interval when both modems work, each supporting its own standard, in order to ensure seamless non-interrupted transfer from one protocol to another.

However, because of the continual need to reduce costs and complexity, interest has grown in the use of reconfigurable modems. These devices allow reconfiguration of the same hardware for implementation of each of several standards while having complexity slightly exceeding the hardware requirements for implementing the most consuming standard. In such modems the same hardware is intended for implementation of several different algorithms or algorithms with several possibilities for basic parameters, like the size of the processed numbers, the number of iterations, etc.

### SUMMARY

In accordance with one aspect of the invention, an integrated chip is provided for use in processing signals encoded in accordance with either one of at least two communication protocols. The chip comprises reconfigurable architecture capable of being selectively arranged into different configurations, at least one configuration corresponding to each respective protocol so as to implement the functionality of the respective protocol with a predetermined complexity, and an intermediate configuration for implementing the hand-off between a first protocol and a second protocol. The intermediate configuration is arranged so as to simultaneously implement the basic functionality of both the first and second protocols during hand-off, and implementation of at least one of the protocols is of lesser complexity than of the corresponding predetermined complexity associated with separately implementing the other of the protocols.

In accordance with another aspect of the invention, a wireless communication device is provided for use in processing signals encoded in accordance with either one of at least two communication protocols, each defined by a series of algorithms. The device comprises: an antenna for receiving or transmitting a signal encoded in accordance with anyone of a plurality of communication protocols; a baseband processor for processing the signals received or transmitted by the antenna; and configware. The configware comprises:

reconfigurable architecture capable of being selectively arranged into different configurations, at least one configuration corresponding to each respective protocol so as to implement the functionality of the respective protocol with a predetermined complexity, and an intermediate configuration for implementing the hand-off between a first protocol and a second protocol, wherein the intermediate configuration is arranged so as to simultaneously implement the basic functionality of both the first and second protocols during hand-off, and implementation of at least one of the protocols is of lesser complexity than of the corresponding predetermined complexity associated with separately implementing the other of the protocols.

In accordance with another aspect of the invention, a method is provided for manufacturing an integrated chip with an architecture for use in processing signals encoded in accordance with any one of a plurality of communication protocols each defined by a series of algorithms, comprising creating configware so as to include: reconfigurable architecture capable of being selectively arranged into separate and different configurations, at least one configuration corresponding to each respective protocol so as to implement the functionality of the respective protocol with a predetermined complexity, and an intermediate configuration for implementing the hand-off between one protocol and a second protocol, wherein the intermediate configuration is arranged so as to simultaneously implement the functionality of both the one and second of the protocols during hand-off, at least one being of a lesser complexity than of the corresponding predetermined complexity associated with separately implementing the at least one protocol.

### GENERAL DESCRIPTION OF THE DRAWINGS

Reference is made to the attached drawings, wherein elements having the same reference character designations represent like elements throughout, and wherein:

FIG. 1 are a series of block diagrams of an integrated chip architecture illustrating the partitioning of during hand-off between signals received in accordance with one protocol and signals received in accordance with a second protocol;

FIG. 2 is a block diagram of an integrated chip architecture designed in accordance with the disclosed teachings; and

FIG. 3 is a block diagram of the megafunction and interconnect blocks of a chip architecture designed in accordance with the disclosed teachings.

### DETAILED DESCRIPTION OF THE DRAWINGS

The following describes a model of a reconfigurable modem configured to provide vertical handoffs, when the information transmission is maintained only with one of the base stations (as in hard handoff), while the mobile agent implements essential algorithmic tasks with the other station(s) (as in a soft handoff). The decision about vertical handoff can be voluntary, or dictated by the changing receipt-transmission conditions. L.-J. Chen et al. “A smart decision model for vertical handoff,” Proc. 4^{th} ANWIRE Int'l Workshop on Wireless Internet and Reconfigurability, Athens, Greece, 2004.

In accordance with one aspect of the present invention, a reconfigurable modem is designed so that hand-off between two standards. The modem comprises reconfigurable architecture capable of being selectively configured into separate and different configurations, at least one configuration corresponding to each respective standard so as to implement the functionality of the respective standard with a predetermined complexity, and an intermediate configuration for implementing the hand-off between one standard and another standard. During the handoff the intermediate configuration is capable of implementing the functionality of both the first and second of the protocols or standards, at least one of which is of a lesser complexity than of the corresponding predetermined complexity associated with the at least one standard. Such a reconfigurable architecture allows parallel and independent implementation of the two standards with a possible decrease in performance of each standard during the hand-off between the two. The term “complexity” as used herein means the amount of resources necessary to implement the total number of algorithmic tasks associated with a particular standard, and can for example, be represented by MIPS (millions of instructions per minute), although the term should not be limited to MIPS. Other measures include power consumption and size, although these two measures are roughly proportional to MIPS.

Typically, the hand-off can be implemented in the following way. Before the hand-off the modem is configured in the mode corresponding to supporting one specific standard. Whenever a decision is made to transfer to a different standard, the modem is reconfigured to an intermediate state in which it is able to support both standards, perhaps with a loss in performance characteristics.

The performance loss associated with the intermediate state of the modem can express itself in, for example, a decrease in the transmission bit-rate, a decrease in error resilience, a decrease in algorithmic performance, a refusal to implement some tasks related to the functioning of the network infrastructure (search, pre-distortion, etc), etc. Such a performance loss can be undertaken unilaterally or in cooperation with the base station.

Examples of standards that can be implemented, and between which hand-off can occur between any two, are any protocols associated with PAN-LAN-MAN networks (e.g. the standards IEEE 802.11, 802.15, 802.16, 802.20, GSM, EDGE, UMTS, DVB, and others).

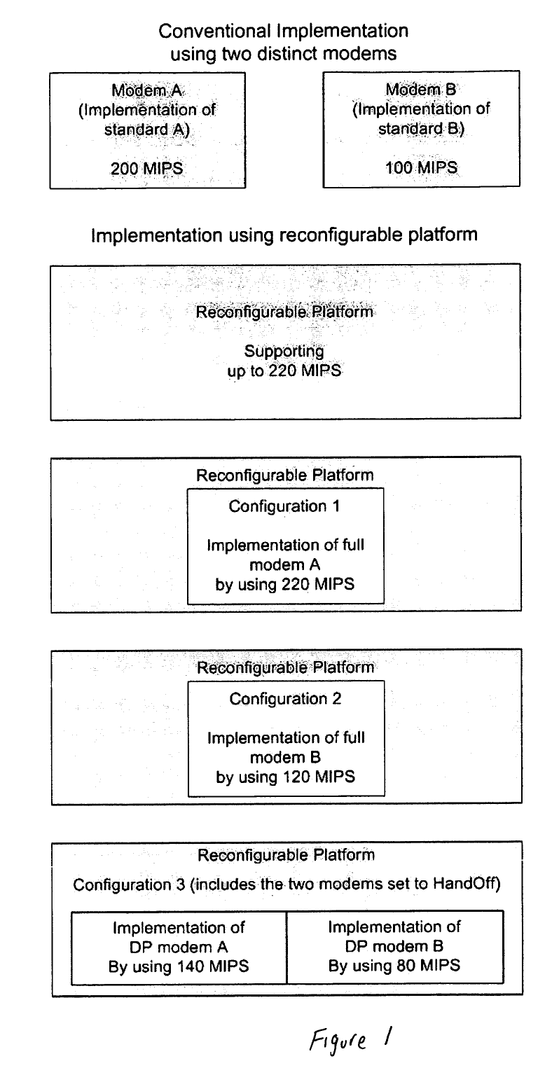

An example of an implementation of a reconfigurable modem for achieving the foregoing is illustrated in FIG. 1. Assume there are two existing standards (A and B), the standard implementation of each requiring a respectively different modem architecture, Modem A and Modem B. In the full mode for single standard implementation, Modem A uses 200 Mips and Modem B uses 100 Mips for implementation of the corresponding communication standards. During hand-off, the standard of Modem A might require 220 Mips, while standard B might require 120 Mips in order to avoid performance losses. Modem C, reconfigured as the intermediate stage, is more complex than either of the Modems A or B; but its complexity is essentially smaller than the sum of the complexities of Modem A and B. In the standard two-modem solutions during the hand-off both modems, A and B, work. In the proposed solution, Modem C is reconfigured as an intermediate stage so that it simultaneously implements both standards, A and B, each with slightly decreased performance, spending 140 Mips for implementation of standard A and 80 Mips for implementation of standard B, which totals to 220 Mips initially assumed in the reconfigurable Modem C.

To illustrate the reconfiguration, consider the part of the reconfigurable modem related to the decoding of convolutional codes. Assume that the same Viterbi decoder, convolution code with K=7 for example, is required for decoding for both standards. During use of only one of the standards, the parameters of the Viterbi decoder, may for example, be set so that the number of soft-bits=6, and the size of the trace-back=3 Kbit. During the hand-off there is need to implement two decoders using the same hardware. This can be done by decreasing the number of soft-bits (e.g. 3 and 3), e.g., the size of the trace-back (e.g. 3 and 3 Kbit), using for example, reduced state decoding, sequential decoding algorithms, etc.

Examples of reconfigurable architecture for the hand-off described above are described in United States Patent Published Application Nos. 2006/0010272 (Jan. 12, 2006) directed to a Low-Power Reconfigurable Architecture For Simultaneous Implementation Of Distinct Communication Standards invented by Doron Solomon and Gilad Garon; 2006/0010188 directed to A Method of and Apparatus for Implementing Fast Orthogonal Transforms of Variable Size invented by Doron Solomon and Gilad Garon; and 2006/0048037 (Mar. 2, 2006) directed to A Method Of And Apparatus For Implementing A Reconfigurable Trellis-Type Decoding invented by Doron Solomon and Gilad Garon, all assigned to the present assignee and all of which are incorporated herein by reference.

United States Patent Published Application Nos. 2006/0010272 (Jan. 12, 2006) describes a chip architecture for use in processing signals encoded in accordance with any one of a plurality of communication protocols each defined by a series of algorithms is disclosed. The chip architecture comprises a plurality of megafunctions, each in the form of reusable, reconfigurable functional blocks for use in implementing different algorithms necessary for implementing the physical layer of each of the communication protocols; and a plurality of switches configured to respond to select control signals so as to interconnect the necessary megafunctions for processing the signals encoded with each of the protocols. Preferably, at least some of the same megafunctions are used with algorithms of two or more protocols.

Accordingly, one preferred embodiment of a system for providing a hand-off according to one aspect of the invention includes an integrated chip architecture using the teachings of United States Patent Published Application Nos. 2006/0010272 (Jan. 12, 2006) to provide the necessary megafunctions, each in the form of reusable, reconfigurable functional blocks for use in implementing different algorithms necessary for implementing the physical layer of each of the communication protocols before, during and after a hand off between two different protocols.

As described in the '272 application, for some signal processing applications, and in particular the execution of signals in accordance with the various known communication protocols, alternative approaches can typically exhibit high degrees of parallelism and are dominated by a few regular kernels of computation that are responsible for a large portion of execution time and energy. For these applications, one could potentially achieve significant power savings by executing the dominant computational kernels of a given class or domain of applications with common features on dedicated, optimized processing elements with minimum energy overhead. Those domains applications that unite into much bigger optimized processing domains are hereinafter called “megafunctions”.

The term “megafunction” has been used in Electronic Design Automation (EDA) to designate “plug-in” or “off-the-shelf functional blocks” that are inserted into a larger electronic design, and connected together resulting in a particular software program design. The resulting software program design includes the off-the-shelf functional blocks integrated with other components of the design in a complied form. This design can be used to program a programmable logic device or layout an ASIC, for example. Such predefined off-the-shelf functional blocks are given various names in the EDA industry. Examples include megafunctions, cores, macrofunctions, and the like. See U.S. Pat. No. 6,401,230. By contrast, in the present disclosure, the term “megafunction” is used to describe reusable functional blocks created as configware, and which can be adaptively reconfigured to implement different (in parameters as well as nature) algorithms necessary for the implementation of the physical layer of anyone of a plurality of communication protocols. As a result signals processed in accordance with any one of the protocols can be processed with the same system architecture. Megafunctions in the present disclosure are not used in a software program design, wherein all parameters are fixed once and forever. In the present disclosure, the megafunctions (as well as other functional blocks of the architecture), the interconnections between and among the megafunctions (and the other functional blocks), and if necessary the parameters of one or more megafunctions can be reconfigured as function of the particular communication protocol.

The result is a domain-specific processor whose design involves trading off the flexibility of a general-purpose programmable device to achieve higher levels of energy efficiency, while maintaining the flexibility to handle a variety of algorithms within the domain of interest. Other processors are designed to examine the basic idea of implemented domains in hardware, such as the Berkeley Pleiades architecture based on this approach (see, for example, A. Abnous and J. Rabaey, “Ultra-Low-Power Domain-Specific Multimedia Processors,” Proceedings of the IEEE VLSI Signal Processing Workshop, San Francisco, October 1996), but with a small granularity of the functions, and are less efficient.

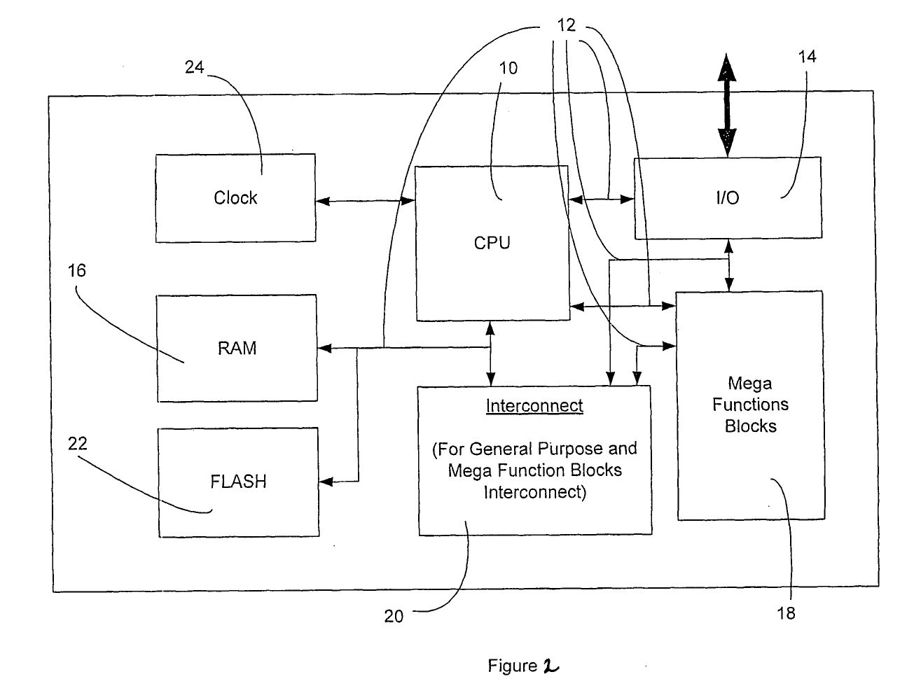

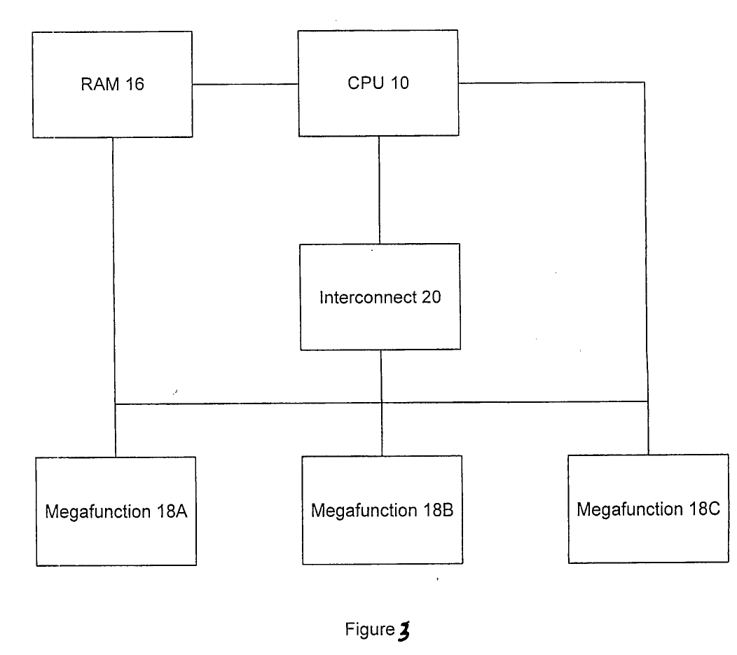

An embodiment of an integrated chip made to comply with the reconfigurable chip architecture requirements for providing the hand-off is shown in FIGS. 2 and 3. The chip architecture requirements will comprise the following basic functional components:

CPU 10 is preferably a relatively small computer processing unit needed for (a) controlling the configware part of the device i.e., net bus 12, I/O block 14, RAM block 16, megafunction block(s) 18, interconnect block 20, flash memory block 22, and clock 24; and (b) fixing the configuration of the megafunctions block(s) 18, as well as the bus 12, I/O block 14, RAM block 16, interconnect block 20, flash memory block 22 and clock 24, depending upon the protocol of the signals be processed by the chip. CPU 10 can also help by computing minor and simple assignments or tasks, and configuring the bus that is used to interconnect the megafunctions and the I/O block.

The net bus 12 is reconfigurable depending on the protocol. I/O block 14 is preferably a configurable I/O block that connects the chip with the outside world. Its tasks include receiving the “compiled software” of the DSP algorithm, and receiving input data and delivering output-processed data. RAM 16 is a random access memory preferably configured to store the “compiled software instructions”, and to cache and buffer data. Megafunctions block 18 is preferably configured to include the major DSP functions of two or more applications, i.e., protocols, which are processed by computing each domain of the DSP functions as one function with extraordinary efficiency. Interconnect block 20 preferably includes a Field Programmable Gate Array (FPGA) configured to make the reconfigurable net bus, which connects all the components of the chip including the CPU 10, I/O block 14, RAM 16, Megafunctions block 18, and Flash Memory 22 and clock 24. The interconnect block can also be configured to perform minor and simple assignments or tasks, preferably in extra memory. Finally, flash memory 20 preferably serves to store data as the chip runs through its programs. Flash memory is preferably in the form of EEPROM that allows multiple memory locations to be erased or written in one programming operation, so that it can operate at higher effective speeds when the systems using it read and write to different locations at the same time. It should be appreciated that for less complex operations, any EEPROM could be used. Information is stored in the flash memory by storing the information on a silicon chip in a way that does not need power to maintain the information in the chip. Consequently, power to the chip can be withdrawn and the information retained in flash memory without consuming any power. In addition, flash memory offers fast read access times and solid-state shock resistance, making flash memory particularly desirable in applications such as data storage on battery-powered devices like cellular phones and PDAs.

The interaction among the CPU 10, megafunction block(s) 18, interconnect block 20 is illustrated in FIG. 3. As shown the architecture is capable of processing signals encoded in accordance with any one of a plurality of communication protocols each defined by a series of algorithms. A plurality of megafunctions are provided as configware, each in the form of reusable, reconfigurable functional blocks 18A, 18B, 18C for implementing different algorithms necessary for implementing the physical layer of each of the communication protocols processed by the system, as well as the hand-off between protocols. The interconnect block 20 includes a plurality of switches configured to respond to select control signals (indicative the protocol of the signals to be processed) from the CPU 10 so as to interconnect the necessary megafunctions 18 for processing the signals encoded with each of the protocols. While three megafunctions are illustrated in FIG. 3, it should be appreciated that any number of megafunctions can be used. The configuration of the blocks 18 is controlled by signals received from RAM 16 as a function of the protocol of the signals being processed. Preferably, at least some of the same megafunctions are used with algorithms of two or more protocols.

In one embodiment at least some of the megafunctions are parameterized, and the parameters of at least some of the megafunctions being adapted to be dynamically changed depending on the communication protocol. In another embodiment, the size of at least some of the buses 12 (shown in FIG. 2) are adapted to be dynamically changed depending on the communication protocol.

The control signals for changing parameters of the parameterized megafunctions, as well as a set of signals for reconfiguring the megafunctions as well as the interconnections of block 20 are preferably stored in memory, such as memory 16, or can be inserted on-line from outside the chip architecture through, for example, I/O block 14. The chip also includes an analyzer preferably made a part of the information stored in RAM 16 and run on CPU 10 is configured so as to determine the protocol of the signal processed by the chip architecture, and apply the necessary control signals so as to configure the switches and interconnect the necessary megafunctions for processing the signals according to the determined protocols. The analyzer can be, for example, an algorithm performed by the CPU 10 of the system architecture, an algorithm for checking the strength of the signals processed by the chip architecture, or simply responsive to the user input to the system architecture. The chip architecture thus includes some type of control for sensing the protocol of the signal, and operating the switches and configuring the megafunctions accordingly. The protocol used to process the signal can also be determined by a hand-off protocol between communication standards.

At least one protocol can implement the same algorithm at different stages of the protocol, as a function of a change in the receipt/transmission conditions with the megafunctions being configured accordingly. At least one protocol can also implement the same algorithm at different megafunctions of the same stage of the protocol as a function of a change in the receipt/transmission conditions. One or more of the megafunctions can be configured to implement any number of algorithms including: orthogonal transforms of the signals, such as cosine and sine transforms, Hilbert transforms and/or Walsh functions; algorithms involving Fourier transforms and/or Walsh-Hadamard transforms; those that perform processing of trellises defining the signals; algorithms that search for the minimum/maximum weight path, the BCJR algorithm for calculation of a MAP, and/or a belief propagation algorithm; and/or those that implement matrix-vector operations, including those which use finite and/or infinite fields and additional operations supported by the matrix-vector operations including polynomial convolutions and vector coordinate permutations. One or more of the megafunctions can be also be configured to implement a process including multiplication of matrices by vectors, scalar product of vectors, and/or interleaving; and/or implement a process of decoding convolution codes. One or more of the megafunctions can also be configured to implement a process of decoding turbo codes, implement a process of decoding low density parity check (LDPC) codes; and/or implement a process of decoding algebraic codes such as Reed-Solomon codes. One or more megafunctions can be configured to implement a process of equalization of the processed signals; a process of synchronizing the processed signals; and/or one that implement a process of MIMO processing of the signals. Finally, one or more of the megafunctions can be configurable so that at least one protocol implements a space-time coding/decoding function. The CPU can also operate the interconnection switches so that different megafunctions can be interconnected to implement the same algorithm at the different stages in order provide efficient allocation of resources for implementing the protocol; and/or at least one parameter of the least one parameterized megafunction is set by an on-line condition, wherein the same algorithm is implemented by the same megafunction with the parameter set by the on-line condition. It will be evident to those skilled in the art that the number of megafunctions is only limited by the number of protocols for which the chip architecture is designed.

For implementation purposes, when using the example of the architecture shown in FIGS. 2 and 3, using only one of standards (either before or after a completed hand-off), a system might, for example, implement a standard Viterbi decoding algorithm requiring 64 states. Such an algorithm can be implemented by using 64 parallel memory elements and the same number of add-compare-select (ACS) blocks. The intermediate state during a hand-off will require supporting simultaneous decoding of two convolutional codes, one for each standard. However, by using the reconfigurable architecture in the example given, using the intermediate configuration to perform both standards during the hand-off means that only half of the memory elements and ACS blocks are available for simultaneously decoding the two convolution codes respectively required for the two standards. Thus, in the example given, only 32 parallel memory elements and 32 ACS blocks are available for each code.

In a further example, the memory elements and ACS blocks are partitioned into two subsets of size of 32. While the partition is described as two equal subsets, it should be apparent, that the partitioning can be into two different subsets depending on the requirements of the two standards. Two reduced Viterbi decoding algorithms are then employed for the process of decoding signals received in accordance with both standards. Reduced state Viterbi decoding is described, for example, M. V. Eyuboglu and S. U. H. Qureshi, “Reduced-state sequence estimation with set partitioning and decision feedback,” IEEE Trans. Commun., vol. 36, pp. 13-20, January 1988; and A. Duel-Hallen and C. Heegard, “Delayed decision-feedback sequence estimation,” IEEE Trans. Commun., vol. 37, pp. 428-436, May 1989.

Application of the reduce state decoding will not require changing interconnection of the blocks in the initial (the existing standard protocol being processed before the hand-off), full Viterbi decoder. Though this intermediate configuration will result in a certain deterioration in performance, it should be sufficient for supporting connectivity during the hand-off process.

It is possible to optimize the partition modem architecture between the algorithmic resources in such a way that the performance loss is minimal. A possibility exists for having several intermediate configurations between the terminal states. Each of several possible intermediate configurations can be predetermined, and the performance characteristics measured for each, i.e., determination of the Mips necessary to execute the two protocols during hand-off. Such intermediate configurations would necessarily include variations in the partitioning of the configware into two parts, one for each protocol during hand-off., and with each intermediate configuration the performance characteristics (Mips) for each protocol during hand-off can be determined. Once the determination is made as to the various alternative arrangements, the best architectural partitioning can be selected that provides the least amount of performance sacrifice to provide an optimal arrangement for hand-off.

For implementation, the chip preferably includes the following: a plurality of megafunctions, each in the form of reusable, reconfigurable functional blocks for use in implementing different algorithms necessary for implementing the physical layer of each of the communication protocols; and a plurality of switches configured to respond to select control signals so as to interconnect the necessary megafunctions for processing the signals encoded with each of the protocols; wherein at least some of the same megafunctions are used with algorithms of the one and second protocols. At least some of the megafunctions are parameterized, the parameters of at least some of the megafunctions are adapted to be dynamically changed depending on the communication protocol. The modem can further include buses interconnecting the megafunctions, and the size of at least some of the buses can be adapted to be dynamically changed depending on the communication protocol. The control signals for changing parameters of the parameterized megafunctions can be stored in memory, or inserted on-line from outside the chip architecture. The chip can further include an interconnect network among the megafunctions, and memory for storing a set of signals for reconfiguring the megafunctions and interconnect network between the megafunctions so as to set the parameters and algorithms associated with the protocol of the signals being processed. The chip can further include an analyzer configured so as to determine the protocol of the signal processed by the chip architecture for each the one and second protocols, and apply the necessary control signals so as to configure the switches and interconnect the necessary megafunctions for processing the signals according to the one protocol prior to the hand-off, both the one and second protocols during the hand-off, and the second protocol after the hand-off. The analyzer can be an algorithm performed by the system architecture. The analyzer algorithm can also be used for checking the strength of the signals processed by the chip architecture. The analyzer can also be responsive to the user input to the system architecture. A control can be included for sensing the protocol of the signal, and operating the switches and configuring the megafunctions accordingly. Finally, at least one protocol can implement the same algorithm at different stages of the protocol, as a function of a change in the receipt/transmission conditions, and/or at least one protocol implements the same algorithm at different megafunctions of the same stage of the protocol as a function of a change in the receipt/transmission conditions.

In accordance with one aspect the invention, the above arrangement can be used to create a wireless communication device for use in processing signals encoded in accordance with either one of at least two communication protocols, each defined by a series of algorithms. Such a wireless communication device comprises: an antenna for receiving and transmitting a signal encoded in accordance with anyone of a plurality of communication protocols; a baseband processor for processing the signals received and transmitted by the antenna; and configware comprising the reconfigurable architecture capable of being selectively arranged into separate and different configurations, at least one configuration corresponding to each respective protocol so as to implement the functionality of the respective protocol with a predetermined complexity, and an intermediate configuration for implementing the hand-off between one protocol and a second protocol, wherein the intermediate configuration is arranged so as to simultaneously implement the functionality of both the one and second of the protocols during hand-off, at least one of which is of a lesser complexity than of the corresponding predetermined complexity associated with separately implementing the at least one protocol. The wireless communication device can function as a transmitter, and the baseband processor used to encode the processed signal in accordance with any one of said protocols prior to transmitting the signal. Similarly, the wireless communication device can function as a receiver, and the baseband processor can be used to decode the processed signal in accordance with any one of said protocols after receiving the processed signal. Finally, the wireless communication device can function both as a transmitter and a receiver, and the baseband processor can be configured to encode the processed signal in accordance with any one of the protocols prior to transmitting an encoded signal, and decode the processed signal in accordance with any one of said protocols after receiving the processed signal.

The modem can be designed to work with any number of different standards so that the hand-off can occur from one to anyone of many other standards. By providing resources that can be shared for different communication protocols, and sacrificing some performance during hand-off, the modem can then be easily implemented as an integrated chip.

What is claimed is:

1. An integrated chip for use in processing signals encoded in accordance with either one of at least two communication protocols, comprising:
reconfigurable architecture capable of being selectively arranged into different configurations, at least one configuration corresponding to each respective protocol so as to implement the functionality of the respective protocol with a predetermined complexity, and an intermediate configuration for implementing the hand-off between a first protocol and a second protocol,
wherein the intermediate configuration is arranged so as to simultaneously implement the basic functionality of both the first and second protocols during hand-off, and implementation of at least one of the protocols is of lesser complexity than of the corresponding predetermined complexity associated with separately implementing the other of the protocols.

2. An integrated chip according to claim 1, comprising:
a plurality of megafunctions, each in the form of reusable, reconfigurable functional blocks for use in implementing different algorithms necessary for implementing the physical layer of each of the communication protocols; and
a plurality of switches configured to respond to select control signals so as to interconnect the necessary megafunctions for processing the signals encoded with each of the protocols;
wherein at least some of the same megafunctions are used with algorithms of the one and second protocols.

3. An integrated chip according to claim 1, wherein at least some of the megafunctions are parameterized, the parameters of at least some of the megafunctions are adapted to be dynamically changed depending on the communication protocol.

4. An integrated chip according to claim 3, further including buses interconnecting the megafunctions, and wherein the size of at least some of the buses are adapted to be dynamically changed depending on the communication protocol.

5. An integrated chip according to claim 3, wherein the control signals for changing parameters of the parameterized megafunctions are stored in memory.

6. An integrated chip according to claim 3, wherein the control signals for changing the parameters of the parameterized megafunctions are inserted on-line from outside the chip architecture.

7. An integrated chip according to claim 2, wherein the control signals are stored in memory.

8. An integrated chip according to claim 2, wherein the control signals are inserted on-line from outside the chip architecture.

9. An integrated chip according to claim 2, further including an interconnect network among the megafunctions, and memory for storing a set of signals for reconfiguring the megafunctions and interconnect network between the megafunctions so as to set the parameters and algorithms associated with the protocol of the signals being processed.

10. An integrated chip according to claim 1, further including an analyzer configured so as to determine the protocol of the signal processed by the chip architecture for each the one and second protocols, and apply the necessary control signals so as to configure the switches and interconnect the necessary megafunctions for processing the signals according to the one protocol prior to the hand-off, both the one and second protocols during the hand-off, and the second protocol after the hand-off.

11. An integrated chip according to claim 10, wherein the analyzer is an algorithm performed by the system architecture.

12. An integrated chip according to claim 10, wherein the analyzer is an algorithm for checking the strength of the signals processed by the chip architecture.

13. An integrated chip according to claim 10, wherein the analyzer is responsive to the user input to the system architecture.

14. An integrated chip according to claim 1, further including a control for sensing the protocol of the signal, and operating the switches and configuring the megafunctions accordingly.

15. An integrated chip according to claim 1, wherein at least one protocol implements the same algorithm at different stages of the protocol, as a function of a change in the receipt/transmission conditions.

16. An integrated chip according to claim 1, wherein at least one protocol implements the same algorithm at different megafunctions of the same stage of the protocol as a function of a change in the receipt/transmission conditions.

17. A wireless communication device for use in processing signals encoded in accordance with either one of at least two communication protocols, each defined by a series of algorithms, comprising:
an antenna for receiving or transmitting a signal encoded in accordance with anyone of a plurality of communication protocols;
a baseband processor for processing the signals received or transmitted by the antenna; and
configware comprising:
reconfigurable architecture capable of being selectively arranged into different configurations, at least one configuration corresponding to each respective protocol so as to implement the functionality of the respective protocol with a predetermined complexity, and an intermediate configuration for implementing the hand-off between a first protocol and a second protocol,
wherein the intermediate configuration is arranged so as to simultaneously implement the basic functionality of both the first and second protocols during hand-off, and implementation of at least one of the protocols is of lesser complexity than of the corresponding predetermined complexity associated with separately implementing the other of the protocols.

18. The wireless communication device according to claim 17, wherein the wireless device is a transmitter, and the baseband processor encodes the processed signal in accordance with any one of said protocols prior to transmitting the signal.

19. The wireless communication device according to claim 17, wherein the wireless device is a receiver, and the baseband processor decodes the processed signal in accordance with any one of said protocols after receiving the processed signal.

20. The wireless communication device according to claim 17, wherein the wireless device is adapted to transmit and receive, and the baseband processor is configured to encode the processed signal in accordance with any one of the protocols prior to transmitting an encoded signal, and decode the processed signal in accordance with any one of said protocols after receiving the processed signal.

21. A method of manufacturing an integrated chip with an architecture for use in processing signals encoded in accordance with any one of a plurality of communication protocols each defined by a series of algorithms, comprising creating configware so as to include:
reconfigurable architecture capable of being selectively arranged into separate and different configurations, at least one configuration corresponding to each respective protocol so as to implement the functionality of the respective protocol with a predetermined complexity, and an intermediate configuration for implementing the hand-off between one protocol and a second protocol, wherein the intermediate configuration is arranged so as to simultaneously implement the functionality of both the one and second of the protocols during hand-off, at least one being of a lesser complexity than of the corresponding predetermined complexity associated with separately implementing the at least one protocol.

22. A method according to claim 21, wherein the step of creating configware includes the step of determining various ways to partition the architecture in the intermediate configuration, and selecting the partitioning of the architecture of the intermediate configuration so that the performance loss associated with the intermediate configuration is at a minimum.
